(19) United States
(12) Patent Application Publication
(10) Pub. No.: US 2010/0325539 A1
(43) Pub. Date: Dec. 23, 2010

(54) WEB BASED SPELL CHECK

(75) Inventors: Chad Arthur Nedzlek, Bellevue, WA (US); Krista Bendig, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/486,783

(22) Filed: Jun. 18, 2009

(51) Int. Cl. G06F 17/21

(52) U.S. Cl. 715/257; 715/259

(57) ABSTRACT

A word entered into a document interface is recorded. The document interface may be part of a web-based application provided through a web browser. A request for determining whether a word is correctly spelled is transmitted across a network. An indication as to whether the word is incorrectly spelled or correctly spelled is then received. The display of the word within the document interface is then transformed from a first state where the word is plainly displayed to a second state where the word is displayed with a user interface marker. The user interface marker may be configured to provide a visual indication that the word is incorrectly spelled. The operations of recording the word, transmitting the request, receiving the indication, and transforming the display of the word from the first state to the second state may be performed in the background of the web-based application without interfering with user workflow within the document interface.

### BACKGROUND

Productivity applications, such as word processors, spreadsheet applications, presentation programs, electronic mail programs, and the like, may provide user interfaces enabling users to create documents and enter text into the documents. Typographical, spelling, and other errors may occur when the user enters the text. As a result, spell check functionality (hereinafter referred to as spell check) has been developed to aid in the identification and correction of these errors.

Productivity applications are commonly implemented as stand-alone software programs installed on personal computers. Modern personal computers are typically distributed from the manufacturer with an abundance of hard disk drive space. Thus, stand-alone productivity applications have the flexibility to locally install large dictionary files on the personal computers. The productivity applications can then quickly access the dictionary files on the personal computers when spell check is requested (also referred to as stand-alone spell check).

In contrast to stand-alone productivity applications, web-based productivity applications and associated dictionary files are typically not installed on personal computers. Instead, web-based applications may be accessed over the Internet through a web browser. Because web-based productivity applications are not installed on personal computers, the web browser may not have access to any locally stored dictionary files. As a result, the web browser may be limited to relying on the web-based productivity applications to remotely perform the spell check (also referred to as web-based spell check).

Web-based spell check is conventionally implemented as a synchronous operation. In an example operational sequence, a user may stop working on a document prior to submitting the document in its entirety to the web-based productivity application over the Internet in order to perform the web-based spell check. While the user is waiting for the web-based spell check to complete, the user may not be able to continue editing the document. In particular, the document may be unavailable for editing until after the web-based productivity application returns the result of the web-based spell check.

The synchronous nature of conventional web-based spell check can be frustrating for users who demand real-time or automated check. Further, user productivity may suffer when users are restricted from working on the document while the web-based spell check is being performed. As a result, a richer web-based spell check more akin to the ease-of-use and functionality of conventional stand-alone spell check may be desired.

It is with respect to these and other considerations that the disclosure made herein is presented.

### SUMMARY

Technologies are described herein for providing an improved web-based spell check. According to embodiments, methods are provided herein for proofing text through a web-based application configured to be accessed through a web browser over a network. According to some methods, a word entered into a document interface is recorded. The document interface may be part of a web-based application provided through a web browser. A request for determining whether the word is correctly spelled is transmitted across a network. When the request is transmitted, an indication as to whether the word is incorrectly spelled or correctly spelled is received. When the indication that the word is incorrectly spelled is received, the display of the word within the document interface is transformed from a first state where the word is plainly displayed to a second state where the word is displayed with a user interface marker. The user interface marker may be configured to provide a visual indication that the word is incorrectly spelled. The operations of recording the word, transmitting the request, receiving the indication, and transforming the display of the word from the first state to the second state may be performed in the background of the web-based application without interfering with user workflow within the document interface.

It should also be appreciated that the above-described subject matter may also be implemented as a computer-controlled apparatus, a computer process, a computing system, or as an article of manufacture such as a computer-storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all of the disadvantages noted in any part of this disclosure.

### BRIEF DESCRIPTION OF THE DRAWINGS

FIG. 1 is a computer architecture diagram showing illustrative computer architectures configured to provide a document interface in which a user can enter and edit text, in accordance with embodiments;

FIG. 2 is a flow diagram illustrating methods for performing a spell check as implemented through a client computer, in accordance with embodiments;

FIG. 3 is a flow diagram illustrating methods for performing a spell check as implemented through a server computer, in accordance with embodiments; and

FIGS. 4A and 4B are computer architecture diagrams showing illustrative computer hardware architectures for computing systems capable of implementing the embodiments presented herein.

### DETAILED DESCRIPTION

The following detailed description is directed to technologies for performing an improved web-based spell check, which may be implemented on a web-based application accessed through a web browser. The improved web-based spell check may provide much of the same functionality found in stand-alone spell check without locally installing dictionary files on a personal computer. Although not so limited, embodiments described herein primarily refer to web-based spell check in the context of web-based productivity applications. However, it should be appreciated that the embodiments described herein may be similarly implemented in any other web-based applications where text is edited.

The improved web-based spell check may operate in an automated manner and in the background of the web-based application so as not to interfere with the user editing the document. The improved web-based spell check may be initiated without user input and may operate without the user even being aware that the web-based spell check is being performed. The improved web-based spell check may display user interface markers (e.g., a red squiggly underline) identifying misspelled words as the user is entering text. The improved web-based spell check may also provide suggestions for misspelled words, correct misspelled words, remove extra spaces, generate a list object, and capitalize lowercase letters. Other proofing functionality may be contemplated by those skilled in the art.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

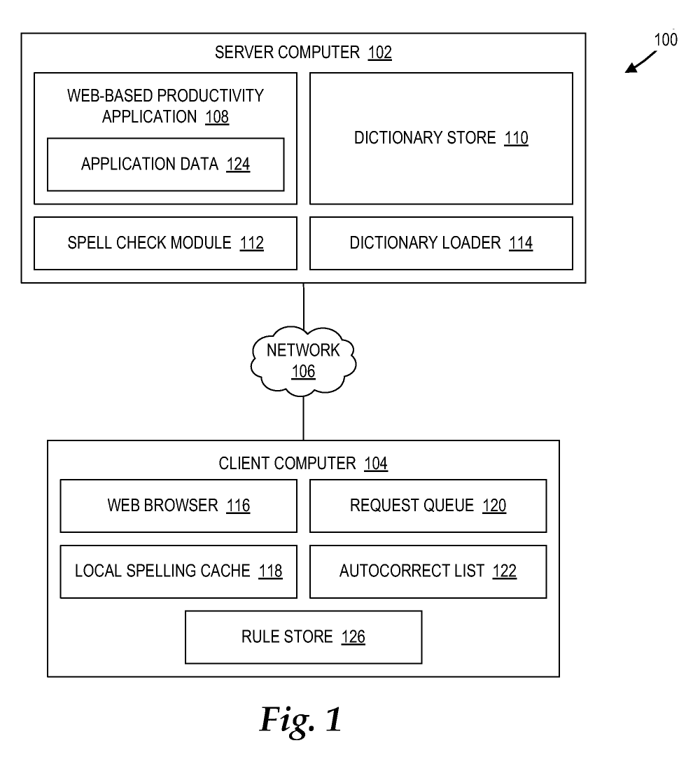

In the following detailed description, references are made to the accompanying drawings that form a part hereof, and which show specific embodiments or examples by way of illustration. Referring now to the drawings, in which like numerals represent like elements through the several figures, a computing system and methodology for providing an improved web-based spell check will be described. In particular, FIG. 1 is a block diagram showing network architectures 100 including one or more server computers 102 coupled to one or more client computers 104 via a network 106.

The server computers 102 may include a web-based productivity application 108 configured to retrieve one or more dictionary files from a dictionary store 110. The web-based productivity application 108 may be embodied, at least in part, as application data 124 (e.g., executable code). The server computer 102 may further include a spell check module 112 and a dictionary loader 114, both of which are detailed further in the description below.

The client computer 104 may include a web browser 116 configured to access the web-based productivity application 108, in particular the application data 124, over the network 106. The client computer 104 may further include a local spelling cache 118, a request queue 120, an autocorrect list 122, and a rule store 126, each of which is detailed further in the description below.

Examples of the web-based productivity application 108 may include, but are not limited to, a word processing application, a spreadsheet application, a presentation application, a note-taking application, and an electronic mail application. The web-based productivity application 108 may be implemented with cross-browser runtime technology, such as JAVA from SUN MICROSYSTEMS, FLASH from ADOBE SYSTEMS, Asynchronous JavaScript and XML (“AJAX”), or other suitable runtime technologies A user may access the web-based productivity application 108 through the web browser 116. In particular, the user may enter a uniform resource locator (“URL”) corresponding to the web-based productivity application 108 into the web browser 116. Upon connecting to the URL, the web browser 116 may download the application data 124, which may contain executable code, such as JAVA, FLASH, AJAX, or other suitable code. The web browser 116 may read and execute the application data 124 in order to display the web-based productivity application 108 and to perform additional features, such as spell check and automatic correction, as described in greater detail below.

Upon reading and executing the application data 124, the web browser 116 may display a user interface (not shown) having an editing surface (e.g., a content pane). A user may enter and edit text through the editing surface that displays a document. Further, upon reading and executing the application data 124, the web browser may further implement various features, such as spell check and automatic correction, directly within the editing surface. As described in greater detail below, spell check and automatic correction may be implemented on the server computer 102 through the spell check module 112, the dictionary loader 114, and the dictionary store 110.

According to some embodiments, the web-based productivity application 108 may mimic much of the functionality found in stand-alone productivity applications. For example, the web-based productivity application 108 may include some of the same features, such as spell check and automatic correction, found in stand-alone productivity applications. However, unlike stand-alone productivity applications which are installed on the client computer 104, the web-based productivity application 108 may be dynamically accessed through the web browser 116 and is generally not installed on the client computer 104. As such, a user may remotely access the web-based productivity application 108 through the web browser 116. This allows the user to access the web-based productivity application 108 from remote locations and with public computers without installing the stand-alone productivity application.

According to embodiments, the application data 124, when executed by the web browser 116, may cause the web browser 116 to perform a spell check in the background while the user enters original text. As a user enters original text into the editing surface, the application data 124, when executed by the web browser 116, may cause the web browser 116 to monitor and record the words being entered. The application data 124 may identify individual words based on a keystroke event entered by the user. For example, a keystroke event may occur when the user depresses the spacebar or a punctuation key (e.g., a period, a comma, etc.), which typically indicates that a word has been entered.

As one or more words are entered by the user and recorded by the web browser 116, the application data 124, when executed by the by the web browser 116, may cause the web browser 116 to generate a request package containing the recorded words and additional information. The web browser 116 may then transmit the request package to the spell check module 112 as a request for the spell check module 112 to perform a spell check on the words contained in the request package. In some embodiments, the request package may be compressed to enable faster transmission of the request package over the network 106. Examples of the additional information may include, but are not limited to, the language of the words in the request package and contextual information about the words in the request package.

The language of the words in the request package may be determined automatically by analyzing various characteristics of the words, such as letter combinations, and various characteristics of the hardware coupled to the client computer 104, such as the keyboard type. The language of the words in the request package may also be determined automatically based on previous user input. For example, if the user previously selected Spanish as the primary language for the user interface, then the web browser 116 may initially assume that the language of the recorded keystrokes is Spanish. If this initial assumption is incorrect, then the user may manually specify the correct language. The contextual information may include any suitable contextual information related to words in the request package. Examples of contextual information may include, but are not limited to, the part of speech of the words, the position of the words within a sentence, and the position of words within a paragraph. In this case, the contextual information may be utilized by the spell check module 112 to aid in spell check operations.

Upon receiving the request package from the web browser 116, the spell check module 112 may extract the words and the additional information from the request package. Based on the specified language of the words, the spell check module 112 may instruct the dictionary loader 114 to load the dictionary corresponding to the specified language from the dictionary store 110. In particular, the dictionary loader 114 may load the dictionary into memory from a database or other storage device within or external to the server computer 102. For example, if the request package specifies that the language of the words is Spanish, then the spell check module 112 may instruct the dictionary loader 114 to load the Spanish dictionary from the dictionary store 110. As described in greater detail below, the spell check module 112 may perform a spell check on the words contained in the request package based on the loaded dictionaries.

In some embodiments, the dictionary loader 114 may concurrently load a predefined number of dictionaries at any given time. By having multiple dictionaries loaded into memory, the spell check module 112 can quickly access loaded dictionaries without having to reload the dictionaries each time a spell check is requested for the corresponding languages. If the number of the dictionaries in the dictionary store 110 is greater than the number of dictionaries that the dictionary loader 114 is configured to load into memory, then the dictionary loader 114 may change the dictionaries loaded into memory as appropriate. In particular, a currently loaded dictionary may be removed from memory in order to make room to load another dictionary. The dictionary that is removed from memory may be chosen based on any suitable criteria. For example, the dictionary that is removed from memory may be the least utilized dictionary in memory or the dictionary that has been not been utilized in the longest time.

In some embodiments, an administrator may adjust the number of dictionaries that the dictionary loader 114 is configured to load into memory at any given time. The capability to adjust the number of dictionaries that are loaded into memory may be useful if the server computer 102 performs other features besides spell check. That is, by adjusting the number of dictionaries that are loaded into memory, the administrator may control the amount of resources (e.g., the limited available memory on the server computer 102) dedicated to spell check.

Although not so limited, the embodiments illustrated in FIG. 1 show the spell check module 112, the dictionary loader 114, and the dictionary store 110 being part of the server computer 102. It should be appreciated that in other embodiments, the server computer 102 may be coupled to a spell check server (not shown). In particular, the spell check server may be dedicated to spell check. For example, the spell check server may be configured to maintain a greater number of the dictionaries from the dictionary store loaded into memory. The spell check server may even be configured maintain all of the dictionaries from the dictionary store 110 loaded into memory.

According to embodiments, the spell check module 112 may be configured to manage multiple requests from multiple client computers 104 across the network 106. In particular, the spell check module 112 may implement any suitable mechanisms to manage multiple requests, and in particular, to maintain efficient and speedy performance. For example, the spell check module 112 may implement a queue (not shown) in which spell check requests are stored until the spell check module 112 can fulfill the requests.

When the desired dictionaries have been loaded into memory, the spell check module 112 may perform a spell check on the words extracted from the request package. Each dictionary may contain, among other information, a listing of correctly spelled words for one or more languages. The spell check module 112 may attempt to match the extracted words with the correctly spelled words. If the extracted word matches one of the correctly spelled words, then the extracted word is considered correctly spelled. If the extracted word does not match one of the correctly spelled words, then the extracted word is considered incorrectly spelled. According to embodiments, any words extracted from the request package that are deemed to be incorrectly spelled may be associated with a spelling state indicating that these words are correctly spelled or incorrectly spelled. The spelling state may also include additional information identifying the word to which the spelling state is associated.

Upon determining whether each word extracted from the request package matches one of the correctly spelled words in the loaded dictionaries and setting the corresponding spelling states, the spell check module 112 may generate a response package containing the spelling states and the additional information identifying the words to which the spelling states are associated. It should be appreciated that the response package may include correct words and/or incorrect words.

Like the request package, the response package may also be compressed. The spell check module 112 may then transmit the response package to the web browser 116. The application data 124, when executed by the web browser 116, may cause the web browser 116 to extract the spelling states and the additional information identifying the words to which the spelling states are associated from the response package. The application data 124 may further cause the web browser 116 to associate the extracted spelling states to the original text based on the extracted additional information identifying the words to which the spelling states are associated.

According to embodiments, the response package may further include contextual information. In particular, the contextual information may be sent back to the client, so that it can be aware of the context with respect to the response package. For example, contextual information such as the position in the sentence may enable the client to correctly correlate the information in the response package back to the appropriate text.

As used herein, the term “original text” refers to the text entered by the user within the editing surface displayed by the web browser 116. Also as used herein, the term “transmitted text” refers to text that is transmitted from the web browser 116 to the spell check module 112, which then performs the spell check on the transmitted text. Prior to the web browser 116 transmitting the transmitted text to the spell check module 112, the transmitted text and the original text may be the same. However, because the spell check is performed in the background, the user may continue entering additional original text, changing previous original text, moving previous original text, and deleting previous original text even while the spell check is performed. Thus, after the web browser 116 transmits the transmitted text to the spell check module 112, the original text may be changed or deleted such that it no longer matches the transmitted text.

Accordingly, prior to associating the extracted spelling states with the original text, the web browser 116 may verify that the original text still matches the transmitted text. In particular, the web browser 116 may maintain information indicating that the original text has been changed or deleted since the request package was transmitted to the spell check module 112. If the web browser 116 determines that the original text has been changed or deleted since the request was transmitted to the spell check module 112, the web browser 116 may discard the extracted spelling states. If the original text has been changed, the web browser 116 may generate a new request package containing the changed text. In some embodiments, if the original text has been moved, the web browser 116 may discard the extracted spelling states. In other embodiments, the web browser 116 may maintain information indicating that the original text remains unchanged in content even when the original text is moved. In this case, the web browser 116 may still associate the extracted spelling states to the moved original text.

When original text has been verified, the application data 124, when executed by the web browser 116, may cause the web browser 116 to display a user interface marker within the editing surface for each misspelled word in the original text. An example of the user interface marker is a red squiggly line under a misspelled word. Other user interface markers may be similarly implemented as contemplated by those skilled in the art. The user interface marker provides a visual indicator enabling the user to easily identify misspelled words in the original text without having to initiate the spell check.

The application data 124, when executed by the web browser 116, may cause the web browser 116 to continually generate and transmit request packages to the spell check module 112 as the user enters additional original text into the editable surface. In some embodiments, the spell check module 112 may be configured to accept one request package at a given time from the web browser 116. For example, the spell check module 112 may limit the number of request packages received in order to maintain an acceptable performance. In this case, the web browser 116 may store additional request packages in the request queue 120 until the spell check module 112 is available to receive another request package.

If the user enters additional original text after a request package has been created but before the web browser 116 transmits the request package to the spell check module 112, the web browser 116 may insert the additional text into the request package. By inserting the additional text into the request package, the web browser 116 can reduce the number of request packages transmitted to the spell check module 112. In the alternative, if the user enters additional original text after a request package has been created but before the web browser 116 transmits the request package to the spell check module 112, the web browser 116 may generate a new request package. For example, the web browser 116 may generate a new request package if the previous request package is full. In particular, the web browser 116 may limit the number of words contained in a request package so as not to overload the spell check module 112.

As previously described, the user interface marker may visually indicate misspelled words within the editing surface. When the user notices the misspelled word, the user may manually correct the misspelled word. In some cases, however, the user may not know the correct spelling of a particular word. To address this possibility, the spell check module 112 may be further configured to provide word suggestions to the user. For example, when the user hovers a mouse cursor over the user interface marker and right-clicks on the mouse, the application data 124, when executed by the web browser 116, may cause the web browser 116 to display one or more word suggestions of correctly spelled words from the loaded dictionaries. In particular, the spell check module 112 may include the word suggestions in the response package that is transmitted to the web browser 116 in response to the request package.

The user may select one of the word suggestions to or manually correct a misspelled word. If the user considers the misspelled word to be correct, the user may specify to the web browser 116 to ignore the misspelled word. After the user corrects the misspelled word or specifies to the web browser 116 to ignore the misspelled word, the web browser 116 may then reset the spelling state associated with the word such that the spelling state indicates that the word is correctly spelled.

The spell check module 112 may utilize any suitable techniques, as contemplated by those skilled in the art, to determine the word suggestions for a given word. With many of these techniques, calculating the word suggestions each time can be relatively expensive. As a result, the application data 124, when executed by the web browser 116, may cause the web browser 116 to store the word suggestions in the local spelling cache 118. For example, the user may mistakenly spell the noun “potato” as “potatoe” numerous times within the document. Without the local spelling cache 118, the web browser 116 may be relegated to retrieving the word suggestions for each and every instance of “potato.” However, by storing the word suggestions for “potatoe” in the local spelling cache 118 after receiving the first response package containing the word suggestions, the web browser 116 may retrieve the word suggestions more quickly from the local spelling cache 118 without having to transmit another request package to the spell check module 112.

The local spelling cache 118 may also be utilized to identify words for which the spell check has already been performed. For example, the local spelling cache 118 may store word suggestions for the misspelled “potatoe” after the spell check module 112 performs the spell check on the first instance of “potatoe” within the original text. When additional instances of “potatoe” are encountered in the original text, the application data 124, when executed by the web browser 116, may cause the web browser 116 to query the local spelling cache 118 prior to generating a request package. In this example, the web browser 116 may query the local spelling cache 118 as to whether the word “potatoe” is incorrectly spelled. The local spelling cache 118 may respond to the query by confirming that the word “pototoe” is incorrectly spelled. By querying the local spelling cache 118, the web browser 116 can also determine misspelled words in the original text based on the local spelling cache 118 without having to transmit another request package to the spell check module 112.

According to some embodiments, the application data 124, when executed by the web browser 116, may cause the web browser 116 to correct mistakes, such as correcting misspelled words, in an automated manner. In particular, the web browser 116 may correct mistakes based on list-based automatic correction and rule-based automatic correction. The web browser 116 may implement list-based automatic correction utilizing the autocorrect list 122 in order to correct spelling mistakes. The autocorrect list 122 may contain a mapping of misspelled words to correctly spelled words. For example, the autocorrect list may contain a mapping of “teh” to “the.” Prior to generating a request package, the web browser 116 may query the autocorrect list 122 to determine whether any of the recorded words are contained in the autocorrect list 122. If any of the recorded words are contained in the autocorrect list 122, then the web browser 116 may replace the incorrectly spelled word in the original text with the correctly spelled word from the autocorrect list 122. If none of the recorded words are contained in the autocorrect list 122, then the web browser 116 may proceed with generating the request package as previously described.

The web browser 116 may implement rule-based automatic correction utilizing the rule store 126. The rule store 126 may store regular expressions, which are mechanisms for identifying strings of text of interest. The regular expressions may be mapped to certain actions. If a given string in the original text matches one of the regular expressions, then the web browser 116 may perform the corresponding action. In some embodiments, the regular expressions may be utilized to detect more complex mistakes, such as capitalizing the first letter of the first word of a sentence or removing extra spaces between words. In further embodiments, the regular expressions may also be utilized to infer user intent in order to create certain objects. For example, if the user types “1.” and depresses the spacebar at the beginning of a paragraph, the web browser 116 may detect that the user's intent is to create a list object. The web browser 116 may then create the list object in an automated manner within the editing surface. In this example, the list object may define certain formatting rules, such as automatic numbering and tabbing, related to creating visually appealing lists. Other inferences and actions may be similarly implemented as contemplated by those skilled in the art.

It should be appreciated that any actions performed by the web browser 116 are made without interrupting the workflow of the user. For example, as the user types the sentence “Potatos are fun to eat,” the web browser 116 may initiate the spell chick, which may further cause the web browser 116 to correct the sentence to “Potatoes are fun to eat.” While this change is made to the original text, the user may full access the editing surface without any interruption.

According to some embodiments, the spelling states may remain associated with the corresponding words. Thus, for example, even if incorrectly spelled words are moved around within a document, the user interface markers will remain shown with the words. When a given portion of text (e.g., a sentence, a paragraph, etc.) is deemed to be correctly spelled, a clean state may be associated with the portion of text. The clean state may be stored along with the associated portion of text in the document file. Thus, when the document file is reopened, additional spell checks are not performed on the correctly spelled portion of text as indicated by the clean state.

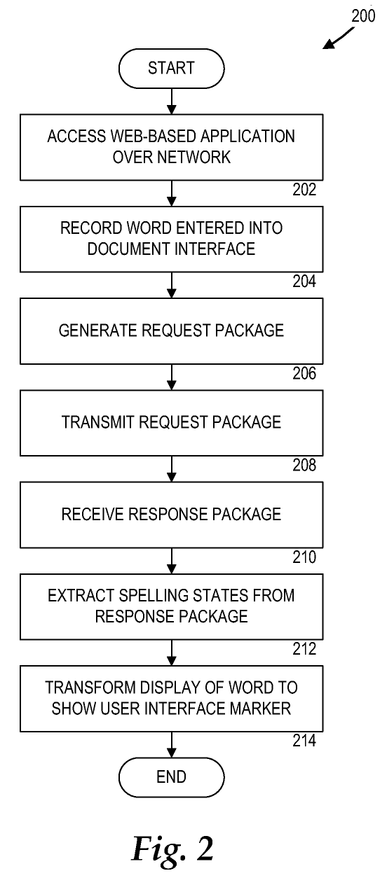

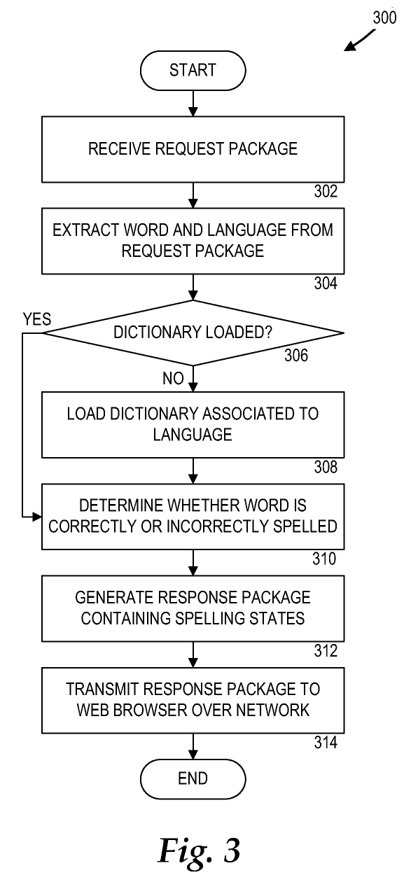

Referring now to FIGS. 2 and 3, additional details regarding the operations of the client computer 104 and the server computer 102 will be described. In particular, FIG. 2 shows a flow diagram illustrating an example process performed by the client computer 104. FIG. 3 shows a flow diagram illustrating an example process performed by the server computer 102.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other specifications of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

In FIG. 2, representative routines 200 may begin at operation 202, where the web browser 116 accesses the web-based productivity application 108 over the network 106. For example, the user may enter a URL for the web-based productivity application 108 into the web browser 116. Upon accessing the web-based productivity application 108, the web browser 116 may download and execute code, such as the application data 124. The application data, when executed by the web browser 116, may cause the web browser 116 to display a document interface (i.e., an editable surface) in which the user can enter text into a document. The routine 200 then proceeds to operation 204.

At operation 204, the application data 124 may cause the web browser 116 to record a word that the user enters into the document interface. The routine 200 then proceeds to operation 206, where the application data 124 may further cause the web browser 116 to generate a request package that contains the recorded word and a language of the word. The routine then proceeds to operation 208.

At operation 208, the application data 124 may cause the web browser 116 to transmit the request package to the spell check module 112 over the network 106. In this case, the request package may serve as a request for the spell check module 112 to perform a spell check on the word contained in the request package. That is, the request package may serve as a request for the spell check module 112 to determine whether the word is correctly spelled. The routine then proceeds to operation 210.

At operation 210, after the web browser 116 transmits the request package to the spell check module 112, the web browser 116 may, in response to the request package, receive a response package from the spell check module 112. The routine 200 then proceeds to operation 212, where the application data 124 causes the web browser 116 to extract the spelling states from the response package. As previously described, the spelling states may indicate that the word is correctly spelled or incorrectly spelled. The routine 200 then proceeds to operation 214.

At operation 214, for those words that are incorrectly spelled as indicated by the spelling states, the application data 124 may cause the web browser 116 to transform a display of the word within the document interface from a first state where the word is plainly displayed to a second state where the word is displayed with a user interface marker. The user interface marker may provide a visual indication, such as a red squiggly line, that the word is incorrectly spelled. According to further embodiments, the application data 124 may also cause the web browser 116 to automatically correct misspelled words based on the autocorrect list 122 and to perform actions based on user intent as inferred based on inference rules contained in the rule store 126.

Representative routines 300 may begin at operation 302, where the spell check module 112 may receive the request package from the web browser 116 across the network 106. The routine 300 then proceeds to operation 304, where the spell check module 112 may extract the word and the language of the word from the request package. The routine 300 the proceeds to operation 306.

At operation 306, the spell check module 112 may determine whether a dictionary corresponding to the language has been loaded into memory. If the dictionary has yet to be loaded into memory, then the routine 300 proceeds to operation 308, where the spell check module 112 loads the dictionary into memory through the dictionary loader 114. After the spell check module 112 loads the dictionary into memory or if the dictionary has been loaded into memory, the routine 300 proceeds to operation 310.

At operation 310, the spell check module 112 determines whether the word is correctly spelled or incorrectly spelled based on the loaded dictionary. The routine 300 then proceeds to operation 312, where the spell check module 112 generates a response package containing the spelling state indicating whether the word is spelled correctly or incorrectly. The routine 300 then proceeds to operation 314, where the spell check module 112 transmits the response to the web browser 116 across the network 106. The dictionary may remain loaded in memory even after the response package is transmitted to the web browser 116.

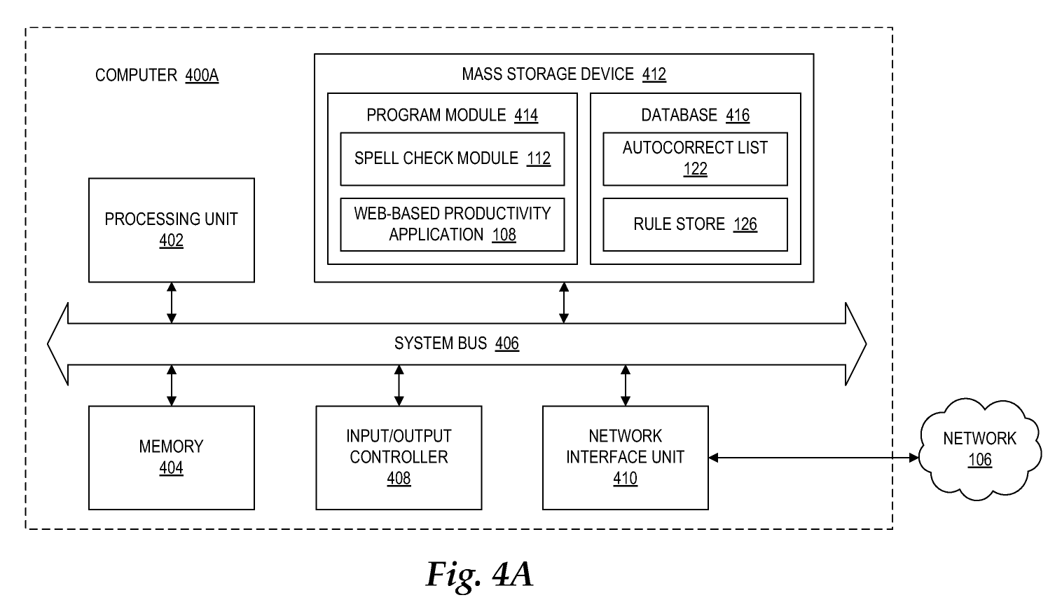

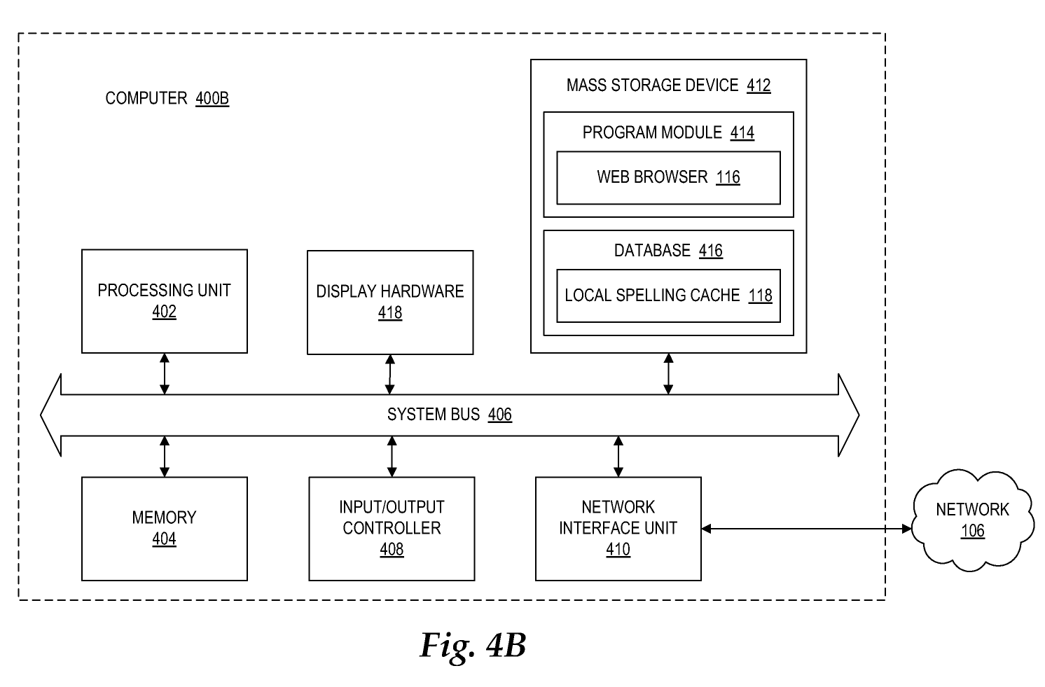

Referring now to FIGS. 4A and 4B, example computer architecture diagrams showing computers 400A and 400B are illustrated. An example implementation of the computer 400A may include the server computer 102 of FIG. 1. An example implementation of the computer 400B may include the client computer 104.

The computers 400A and 400B include a processing unit 402 (“CPU”), a system memory 404, and a system bus 406 that couples the memory 404 to the CPU 402. The computers 400A and 400B further include a mass storage device 412 for storing one or more program modules 414 and one or more databases 416. As illustrated in FIG. 4A, examples of the program modules 414 may include the spell check module 112 and the web-based productivity application 108. As illustrated in FIG. 4B, an example of the program modules 414 may further include the web browser 116. As illustrated in FIG. 4A, examples of the databases 416 may include the autocorrect list 122 and the rule store 126. As illustrated in FIG. 4B, examples the databases 416 may further include the local spelling cache 118.

The mass storage device 412 is connected to the CPU 402 through a mass storage controller (not shown) connected to the bus 406. The mass storage device 412 and its associated computer-storage media provide non-volatile storage for the computer 400. Although the description of computer-storage media contained herein refers to a mass storage device, such as a hard disk or CD-ROM drive, it should be appreciated by those skilled in the art that computer-storage media can be any available computer storage media that can be accessed by the computers 400A and 400B.

By way of example, and not limitation, computer-storage media may include volatile and non-volatile, removable and non-removable media implemented in any method or technology for storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computers 400A and 400B.

According to various embodiments, the computers 400A and 400B may operate in a networked environment using logical connections to remote computers through a network 106. The computers 400A and 400B may connect to the network 106 through a network interface unit 410 connected to the bus 406. It should be appreciated that the network interface unit 410 may also be utilized to connect to other types of networks and remote computer systems. The computers 400A and 400B may also include an input/output controller 408 for receiving and processing input from a number of input devices, including a keyboard, a mouse, a microphone, and a game controller. Similarly, the input/output controller 408 may provide output to a display or other type of output device (not shown).

The bus 406 may enable the processing unit 402 to read code and/or data to/from the mass storage device 412 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 414 may include software instructions that, when loaded into the processing unit 402 and executed, cause the computer 400 to provide the improved spell check. The program modules 414 may also provide various tools or techniques by which the computer 400 may participate within the overall systems or operating environments using the components, flows, and data structures discussed throughout this description. For example, the program modules 414 may implement the improved spell check. As illustrated in FIG. 4B, the program modules 414 may also be implemented through display hardware 418 in the computer 400B. In particular, the display hardware 418 may perform transformations of the user interface as displayed through the display hardware 418.

In general, the program modules 414 may, when loaded into the processing unit 402 and executed, transform the processing unit 402 and the overall computer 400 from a general-purpose computing system into a special-purpose computing system customized to provide the improved spell check. The processing unit 402 may be constructed from any number of transistors or other discrete circuit elements, which may individually or collectively assume any number of states. More specifically, the processing unit 402 may operate as a finite-state machine, in response to executable instructions contained within the program modules 414. These computer-executable instructions may transform the processing unit 402 by specifying how the processing unit 402 transitions between states, thereby transforming the transistors or other discrete hardware elements constituting the processing unit 402.

Encoding the program modules 414 may also transform the physical structure of the computer-storage media. The specific transformation of physical structure may depend on various factors, in different implementations of this description. Examples of such factors may include, but are not limited to: the technology used to implement the computer-storage media, whether the computer-storage media are characterized as primary or secondary storage, and the like. For example, if the computer-storage media are implemented as semiconductor-based memory, the program modules 414 may transform the physical state of the semiconductor memory, when the software is encoded therein. For example, the program modules 414 may transform the state of transistors, capacitors, or other discrete circuit elements constituting the semiconductor memory.

As another example, the computer-storage media may be implemented using magnetic or optical technology. In such implementations, the program modules 414 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that technologies for providing the improved spell check are presented herein. Through the utilization of the technologies and concepts presented herein, an asynchronous web-based spell check may be provided. In particular, the web-based spell check may be performed in the background in an automated manner while a user enters and text into a document interface displayed through a web browser. The web-based spell check may provide, among other proofing features, a user interface marker to identify misspelled words, automatic correction of misspelled words, suggestions for misspelled words, and automatic actions based on inferred intent. Because the web-based spell check is performed in the background, the user may continue to enter next text and edit existing text even while the spell check is being performed.

Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for proofing text through a web-based application configured to be accessed through a web browser over a network, the computer-implemented method comprising computer-implemented operations for:
recording a word entered into a document interface of a web-based application provided through the web browser;
transmitting, across the network, a request for determining whether the word is correctly spelled;
in response to transmitting the request, receiving an indication as to whether the word is incorrectly spelled or correctly spelled;
in response to receiving the indication that the word is incorrectly spelled, transforming a display of the word within the document interface from a first state where the word is plainly displayed to a second state where the word is displayed with a user interface marker, the user interface marker configured to provide a visual indication that the word is incorrectly spelled; and
wherein the operations of recording the word, transmitting the request, receiving the indication, and transforming the display of the word from the first state to the second state are performed in a background of the web-based application without interfering with user workflow within the document interface.

2. The computer-implemented method of claim 1, wherein recording a word entered into a document interface comprises executing scripting language code at the web browser, the scripting language code configured to cause the web browser to record the word entered into the document interface;
wherein transmitting a request for determining whether the word is correctly spelled comprises executing the scripting language code at the web browser, the scripting language code further configured to cause the web browser to determine whether the word is correctly spelled; and
wherein transforming a display of the word within the document interface from a first state transforming a display of the word within the document interface from a first state where the word is plainly displayed into a second state where the word is displayed with a user interface marker comprises executing the scripting language code at the web browser, the scripting language code further configured to cause the web browser to transform the display of the word within the document interface from the first state to the second state.

3. The computer-implemented method of claim 1, the computer-implemented method further comprising computer-implemented operations for:
in further response to transmitting the request, receiving an automatic correction list comprising a mapping between a current spelling of the word and a correct spelling of the word;
in response to receiving the automatic correction list, transforming the display of the word within the document interface from the first state where the current spelling of the word is shown to a third state where the correct spelling of the word is shown in accordance with mapping in the automatic correction list; and
wherein the operation of the transforming the display of the word from the first state to the third state is performed in the background of the web-based application without interfering with user workflow within the document interface.

4. The computer-implemented method of claim 1, the computer-implemented method further comprising computer-implemented operations for:
in further response to transmitting the request, receiving correctly spelled suggestions for the word in addition to the indication that the word is incorrectly spelled;
storing the suggestions in a local spelling cache accessible by the web browser;
receiving an instruction to display the correctly spelled suggestions for the word; and
in response to receiving the instruction to display the correctly spelled suggestions for the word, transforming the display of the word within the document interface from the second state where the word is displayed with the user interface marker to a fourth state where the correctly spelled suggestions are displayed at or near the user interface marker.

5. The computer-implemented method of claim 1, the computer-implemented method further comprising computer-implemented operations for:
receiving inference rules comprising a mapping between regular expressions and actions performed by the web browser on the document interface;
determining whether text entered into the document interface matches one of the regular expressions in the inference rules; and
in response to determining that the text matches one of the regular expressions, transforming the document interface by performing the action corresponding to the matched regular expression;
wherein the operation of transforming the document interface by performing the action corresponding to the matched regular expression is performed in the background of the web-based application without interfering with user workflow within the document interface.

6. The computer-implemented method of claim 1, the computer-implemented method further comprising computer-implemented operations for:
recording a second word entered into the document interface in the web-based application provided through the web browser;
determining whether a response to the request has been received;
in response to determining that the response to the request has been received, transmitting, across the network, a second request for determining whether the second word is correctly spelled; and
in response to determining that the response to the request has not been received, storing the second word in a request queue until the response to the request is received.

7. The computer-implemented method of claim 1, wherein the request comprises a request package containing the word and a language of the word.

8. The computer-implemented method of claim 8, the computer-implemented method further comprising computer-implemented operations for:
in response to transmitting the request, receiving an indication that a dictionary corresponding to the language of the word is nonexistent; and
in response to receiving the indication that the dictionary corresponding to the language of the word is nonexistent, restricting future request for determining whether other words corresponding to the language are correctly spelled.

9. The computer-implemented method of claim 1, the computer-implemented method further comprising computer-implemented operations for:
in response to transmitting the request, receiving an indication that a server computer is unable to handle the request; and
in response to receiving the indication that the server computer is unable to handle the request, retransmitting, across the network and at intervals, the request for determining whether the word is correctly spelled until the server computer accepts the request, the intervals increasing over time as additional indications that the server computer is unable to handle the request are received.

10. The computer-implemented method of claim 1, wherein the word is displayed with the user interface marker if the word is moved to another part of the document interface.

11. A computer system, comprising:
a processor;
a memory operatively coupled to the processor; and
a program module (i) which executes in the processor from the memory and (ii) which, when executed by the processor, causes the computer system to proof a document through a web-based application configured to be accessed through a web browser over a network by
receiving a request package from the web browser across the network,
extracting a word and a language of the word from the request package,
determining whether a dictionary corresponding to the language has been loaded into memory,
in response to determining that the dictionary corresponding to the language has not been loaded into memory, loading the dictionary into memory,
upon loading the dictionary into memory or in response to determining that the dictionary corresponding to the language has been loaded into memory, determining whether the word is spelled correctly based on the loaded dictionary,
generating a response package containing an indication of whether word is spelled correctly or incorrectly, and
transmitting the response package to the web browser across the network, the dictionary remaining loaded in memory after the response package is transmitted to the web browser.

12. The computer system of claim 11, wherein the memory is configured to load multiple dictionaries corresponding to different languages; and wherein new dictionaries are loaded into the memory by removing old dictionaries from the memory.

13. The computer system of claim 11, wherein the program module is configured to handle multiple request packages from multiple web browsers.

14. The computer system of claim 11, wherein the response package comprises correctly spelled suggestions for the word.

15. The computer system of claim 11, wherein the response package further comprises an automatic correction list including a mapping between a current spelling of the word and a correct spelling of the word from the loaded dictionary.

16. The computer system of claim 11, wherein the response package further comprises inference rules including a mapping between regular expressions and actions performed by the web browser.

17. A computer-storage medium having computer-executable instructions stored thereon which, when executed by a computer, cause the computer to:
access, through a web browser and over network, a web-based application on a server computer, the web-based application causing the web browser to display a document interface;
record a word entered into the document interface;
generate a request package comprising the word and a language of the word;
transmit the request package to a spell check module over the network, the request package configured to request the spell check module to determine whether the word is spelled correctly;
in response to transmitting the request, receive a response package from the spell check module;
extract an indication as to whether the word is incorrectly spelled or correctly spelled from the response package;
in response to extracting the indication that the word is incorrectly spelled, transform a display of the word within the document interface from a first state where the word is plainly displayed to a second state where the word is displayed with a user interface marker, the user interface marker configured to provide a visual indication that the word is incorrectly spelled; and
wherein the operations of recording the word, transmitting the request, receiving the indication, and transforming the display of the word from the first state to the second state are performed in a background of the web-based application without interfering with user workflow within the document interface.

18. The computer-storage medium of claim 17 having further computer-executable instructions stored thereon which, when executed by a computer, cause the computer to:
in further response to transmitting the request, receive an automatic correction list comprising a mapping between a current spelling of the word and a correct spelling of the word; and
in response to receiving the automatic correction list, transform the display of the word within the document interface from the first state where the current spelling of the word is shown to a third state where the correct spelling of the word is shown in accordance with mapping in the automatic correction list;
wherein the operation of the transforming the display of the word from the first state to the third state is performed in the background of the web-based application without interfering with user workflow within the document interface.

19. The computer-storage medium of claim 17 having further computer-executable instructions stored thereon which, when executed by a computer, cause the computer to:
in further response to transmitting the request, receive correctly spelled suggestions for the word in addition to the indication that the word is incorrectly spelled;
store the suggestions in a local spelling cache accessible by the web browser;
receive an instruction to display the correctly spelled suggestions for the word; and
in response to receiving the instruction to display the correctly spelled suggestions for the word, transform the display of the word within the document interface from the second state where the word is displayed with the user interface marker to a fourth state where the correctly spelled suggestions are displayed at or near the user interface marker.

20. The computer-storage medium of claim 17 having further computer-executable instructions stored thereon which, when executed by a computer, cause the computer to:
receive inference rules comprising a mapping between regular expressions and actions performed by the web browser on the document interface;
determine whether text entered into the document interface matches one of the regular expressions in the inference rules; and
in response to determining that the text matches one of the regular expressions, transform the document interface by performing the action corresponding to the matched regular expression;
wherein the operation of transforming the document interface by performing the action corresponding to the matched regular expression is performed in the background of the web-based application without interfering with user workflow within the document interface.
